(19) United States
(12) Patent Application Publication
(10) Pub. No.: US 2026/0214574 A1
(43) Pub. Date: Jul. 23, 2026

(54) SCHEDULING ASPECTS FOR USER EQUIPMENT POWER SAVING MODE

(71) Applicant: QUALCOMM Incorporated, San Diego, CA (US)

(72) Inventors: Diana MAAMARI, San Diego, CA (US); Gabi SARKIS, San Diego, CA (US); Jing JIANG, San Diego, CA (US)

(21) Appl. No.: 19/028,627

(22) Filed: Jan. 17, 2025

(51) Int. Cl. H04W 52/02; H04W 72/0457; H04W 72/51

(52) U.S. Cl. CPC H04W 52/0229; H04W 52/0216; H04W 72/0457; H04W 72/51

(57) ABSTRACT

Methods, systems, and devices for wireless communications are described. A user equipment (UE) may receive a message that activates a power saving mode for the UE, the power saving mode comprising a set of monitoring occasions for the UE to monitor for one or more grants that schedule wireless communications, wherein the message identifies a timing constraint where the wireless communications are to be scheduled in non-contiguous slots. The UE may monitor the set of monitoring occasions for the one or more grants according to the power saving mode. The UE may perform the wireless communications according to a result of the monitoring.

### FIELD OF TECHNOLOGY

The following relates to wireless communications, including scheduling aspects for user equipment power saving mode.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communications by a user equipment (UE) is described. The method may include receiving a message that activates a power saving mode for the UE, the power saving mode including a set of monitoring occasions for the UE to monitor for one or more grants that schedule wireless communications, where the message identifies a timing constraint where the wireless communications are to be scheduled in non-contiguous slots, monitoring the set of monitoring occasions for the one or more grants according to the power saving mode, and performing the wireless communications according to a result of the monitoring.

A UE for wireless communications is described. The UE may include one or more memories storing processor executable code, and one or more processors coupled with the one or more memories. The one or more processors may individually or collectively be operable to execute the code to cause the UE to receive a message that activates a power saving mode for the UE, the power saving mode including a set of monitoring occasions for the UE to monitor for one or more grants that schedule wireless communications, where the message identifies a timing constraint where the wireless communications are to be scheduled in non-contiguous slots, monitor the set of monitoring occasions for the one or more grants according to the power saving mode, and perform the wireless communications according to a result of the monitoring.

Another UE for wireless communications is described. The UE may include means for receiving a message that activates a power saving mode for the UE, the power saving mode including a set of monitoring occasions for the UE to monitor for one or more grants that schedule wireless communications, where the message identifies a timing constraint where the wireless communications are to be scheduled in non-contiguous slots, means for monitoring the set of monitoring occasions for the one or more grants according to the power saving mode, and means for performing the wireless communications according to a result of the monitoring.

A non-transitory computer-readable medium storing code for wireless communications is described. The code may include instructions executable by one or more processors to receive a message that activates a power saving mode for the UE, the power saving mode including a set of monitoring occasions for the UE to monitor for one or more grants that schedule wireless communications, where the message identifies a timing constraint where the wireless communications are to be scheduled in non-contiguous slots, monitor the set of monitoring occasions for the one or more grants according to the power saving mode, and perform the wireless communications according to a result of the monitoring.

In some examples of the method, user equipment (UEs), and non-transitory computer-readable medium described herein, the timing constraint identified in the message includes a K0 indication or a K2 indication.

In some examples of the method, user equipment (UEs), and non-transitory computer-readable medium described herein, the K0 indication or the K2 indication may be set to zero.

In some examples of the method, user equipment (UEs), and non-transitory computer-readable medium described herein, the K0 indication or the K2 indication may be set to a value that may be based on a periodicity of monitoring occasions in the set of monitoring occasions, the value being selected to schedule the wireless communications in the non-contiguous slots.

In some examples of the method, user equipment (UEs), and non-transitory computer-readable medium described herein, the timing constraint identified in the message includes a timing offset value between subsequently scheduled wireless communications in the non-contiguous slots.

In some examples of the method, user equipment (UEs), and non-transitory computer-readable medium described herein, one or more values for second K0 indications or second K2 indications associated with second wireless communications may be excluded according to one or more values for a first K0 indication or a first K2 indication associated with a first wireless communication scheduled prior to the second wireless communications.

In some examples of the method, user equipment (UEs), and non-transitory computer-readable medium described herein, the timing offset value may be based on at least one of a buffer size of the UE, a processing delay of the UE, or any combination thereof.

In some examples of the method, user equipment (UEs), and non-transitory computer-readable medium described herein, the message includes a bandwidth part configuration message that activates the power saving mode for the UE.

In some examples of the method, user equipment (UEs), and non-transitory computer-readable medium described herein, the message includes a grant that schedules a first wireless communications and activates the power saving mode for the UE.

Some examples of the method, user equipment (UEs), and non-transitory computer-readable medium described herein may further include operations, features, means, or instructions for transmitting a UE capability message that identifies a supported timing constraint of the UE, where the timing constraint may be based on the supported timing constraint of the UE.

In some examples of the method, user equipment (UEs), and non-transitory computer-readable medium described herein, the timing constraint may be configured on a per-bandwidth part (BWP)-basis associated with the power saving mode or may be adapted within a BWP configured for the UE.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports scheduling aspects for user equipment (UE) power saving mode in accordance with one or more aspects of the present disclosure.

FIG. 2 shows an example of a wireless communications system that supports scheduling aspects for UE power saving mode in accordance with one or more aspects of the present disclosure.

FIG. 3 shows an example of a scheduling configuration that supports scheduling aspects for UE power saving mode in accordance with one or more aspects of the present disclosure.

FIG. 4 shows an example of a scheduling configuration that supports scheduling aspects for UE power saving mode in accordance with one or more aspects of the present disclosure.

FIGS. 5 and 6 show block diagrams of devices that support scheduling aspects for UE power saving mode in accordance with one or more aspects of the present disclosure.

FIG. 7 shows a block diagram of a communications manager that supports scheduling aspects for UE power saving mode in accordance with one or more aspects of the present disclosure.

FIG. 8 shows a diagram of a system including a device that supports scheduling aspects for UE power saving mode in accordance with one or more aspects of the present disclosure.

FIGS. 9 and 10 show flowcharts illustrating methods that support scheduling aspects for UE power saving mode in accordance with one or more aspects of the present disclosure.

### DETAILED DESCRIPTION

Wireless networks may use energy efficient scheduling for a user equipment (UE) power saving mode. This may include a reduced peak throughput based on the UE not being scheduled for communications following wideband communications. For example, this absence of or gap in scheduling may allow the UE to transition its baseband to a low power state while decoding the wideband wireless communications. The baseband processing capabilities or delays at the UE may be based on a buffer size of the UE as well as the processing capabilities of the UE. The UE may also be scheduled for a power saving mode where the UE performs sparse control channel monitoring (e.g., every n^{th} slot). However, such power saving mode configuration and activation does not provide a mechanism to also enable energy efficient scheduling operations. This may result in a UE being scheduled with back-to-back (e.g., in contiguous slots) wireless communications, which may prevent the UE from transitioning to the power saving mode.

Accordingly, aspects of the techniques described herein provide for improved energy efficient scheduling of the UE with at least a minimum threshold of gap(s) between slots scheduled for wireless communications when the UE is operating according to a power saving mode. For example, the UE may receive a message that activates a power saving mode for the UE. The power saving mode may correspond to a set of monitoring occasions for the UE to monitor for one or more grants that schedule wireless communications. In some aspects, the message identifies a timing constraint (e.g., to enable energy efficient scheduling) where the wireless communications are to be scheduled in non-contiguous slots. The UE may monitor the set of monitoring occasions for the one or more grants according to the power saving mode and perform the wireless communications according to a result of the monitoring.

Aspects of the disclosure are initially described in the context of wireless communications systems. Aspects of the disclosure are further illustrated by and described with reference to apparatus diagrams, system diagrams, and flowcharts that relate to scheduling aspects for UE power saving mode.

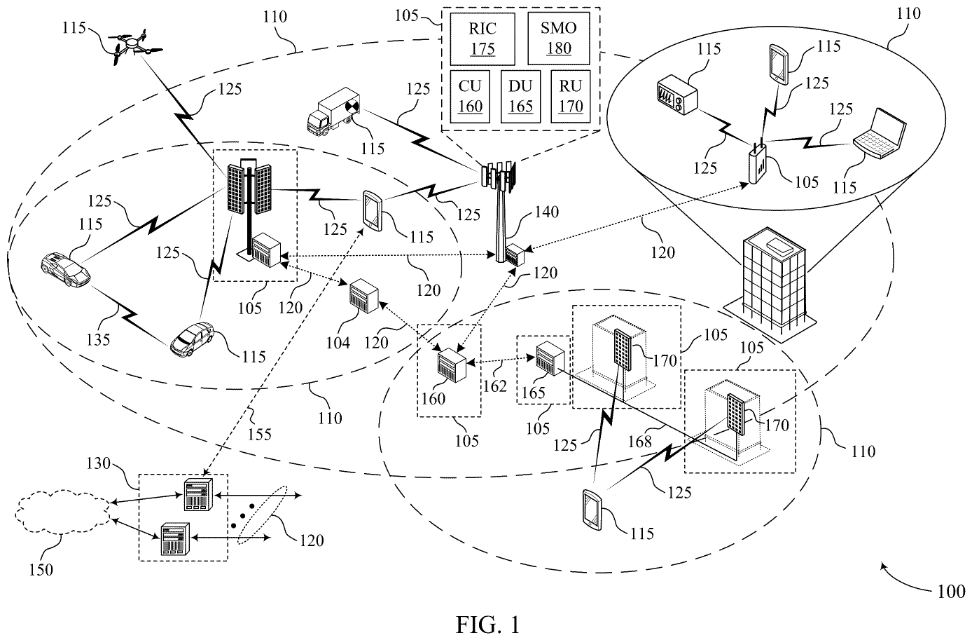

FIG. 1 shows an example of a wireless communications system 100 that supports scheduling aspects for UE power saving mode in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3(L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1(L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

For instance, an access network (AN) or RAN may include communications between access nodes (e.g., an IAB donor), IAB node(s) 104, and one or more UEs 115. The IAB donor may facilitate connection between the core network 130 and the AN (e.g., via a wired or wireless connection to the core network 130). That is, an IAB donor may refer to a RAN node with a wired or wireless connection to the core network 130. The IAB donor may include one or more of a CU 160, a DU 165, and an RU 170, in which case the CU 160 may communicate with the core network 130 via an interface (e.g., a backhaul link). The IAB donor and IAB node(s) 104 may communicate via an F1 interface according to a protocol that defines signaling messages (e.g., an F1 AP protocol). Additionally, or alternatively, the CU 160 may communicate with the core network 130 via an interface, which may be an example of a portion of a backhaul link, and may communicate with other CUs (e.g., including a CU 160 associated with an alternative IAB donor) via an Xn-C interface, which may be an example of another portion of a backhaul link.

IAB node(s) 104 may refer to RAN nodes that provide IAB functionality (e.g., access for UEs 115, wireless self-backhauling capabilities). A DU 165 may act as a distributed scheduling node towards child nodes associated with the IAB node(s) 104, and the IAB-MT may act as a scheduled node towards parent nodes associated with IAB node(s) 104. That is, an IAB donor may be referred to as a parent node in communication with one or more child nodes (e.g., an IAB donor may relay transmissions for UEs through other IAB node(s) 104). Additionally, or alternatively, IAB node(s) 104 may also be referred to as parent nodes or child nodes to other IAB node(s) 104, depending on the relay chain or configuration of the AN. The IAB-MT entity of IAB node(s) 104 may provide a Uu interface for a child IAB node (e.g., the IAB node(s) 104) to receive signaling from a parent IAB node (e.g., the IAB node(s) 104), and a DU interface (e.g., a DU 165) may provide a Uu interface for a parent IAB node to signal to a child IAB node or UE 115.

For example, IAB node(s) 104 may be referred to as parent nodes that support communications for child IAB nodes, or may be referred to as child IAB nodes associated with IAB donors, or both. An IAB donor may include a CU 160 with a wired or wireless connection (e.g., backhaul communication link(s) 120) to the core network 130 and may act as a parent node to IAB node(s) 104. For example, the DU 165 of an IAB donor may relay transmissions to UEs 115 through IAB node(s) 104, or may directly signal transmissions to a UE 115, or both. The CU 160 of the IAB donor may signal communication link establishment via an F1 interface to IAB node(s) 104, and the IAB node(s) 104 may schedule transmissions (e.g., transmissions to the UEs 115 relayed from the IAB donor) through one or more DUs (e.g., DUs 165). That is, data may be relayed to and from IAB node(s) 104 via signaling via an NR Uu interface to MT of IAB node(s) 104 (e.g., other IAB node(s)). Communications with IAB node(s) 104 may be scheduled by a DU 165 of the IAB donor or of IAB node(s) 104.

In the case of the techniques described herein applied in the context of a disaggregated RAN architecture, one or more components of the disaggregated RAN architecture may be configured to support scheduling aspects for UE power saving mode as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

In some examples, such as in a carrier aggregation configuration, a carrier may have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different RAT).

The communication link(s) 125 of the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular RAT (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δƒ) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs. The time intervals for the network entities 105 or the UEs 115 may be

expressed in multiples of a basic time unit which may, for example, refer to a sampling period of Tₛ=1/(Δƒₘₐₓ·N_{ƒ}) seconds, for which Δƒₘₐₓ may represent a supported subcarrier spacing, and N_{ƒ} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023). Each frame may include multiple consecutively-numbered subframes or

slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{ƒ}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID)). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a network entity 105 operating with lower power (e.g., a base station 140 operating with lower power) relative to a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or more cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may support synchronous or asynchronous operation. For synchronous operation, network entities 105 (e.g., base stations 140) may have similar frame timings, and transmissions from different network entities (e.g., different ones of the network entities 105) may be approximately aligned in time. For asynchronous operation, network entities 105 may have different frame timings, and transmissions from different network entities (e.g., different ones of network entities 105) may, in some examples, not be aligned in time. The techniques described herein may be used for either synchronous or asynchronous operations.

Some UEs 115, such as MTC or IoT devices, may be relatively low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 may include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by a transmitting device (e.g., a network entity 105 or a UE 115) along a single beam direction (e.g., a direction associated with the receiving device, such as another network entity 105 or UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., the communication link(s) 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in relatively poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

A UE 115 may receive a message that activates a power saving mode for the UE 115, the power saving mode comprising a set of monitoring occasions for the UE 115 to monitor for one or more grants that schedule wireless communications, wherein the message identifies a timing constraint where the wireless communications are to be scheduled in non-contiguous slots. The UE 115 may monitor the set of monitoring occasions for the one or more grants according to the power saving mode. The UE 115 may perform the wireless communications according to a result of the monitoring.

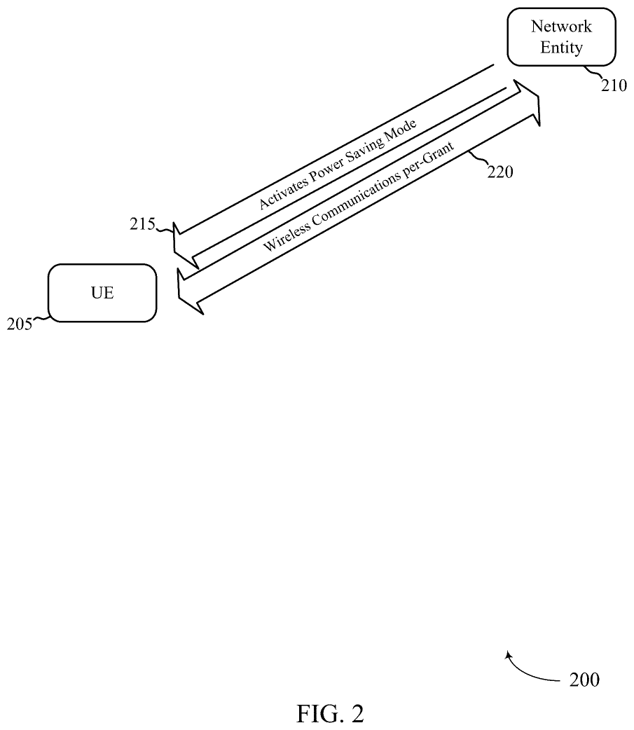

FIG. 2 shows an example of a wireless communications system 200 that supports scheduling aspects for UE power saving mode in accordance with one or more aspects of the present disclosure. Aspects of the wireless communications system 200 may be implemented by or implemented at the wireless communications system 100. The wireless communications system 200 may include a UE 205 and a network entity 210, which may be examples of the corresponding devices described herein.

Wireless networks may support energy efficient scheduling for UE. This may include a reduced peak throughput that is achieved by guaranteeing that the UE doesn't receive any scheduling following a wideband physical downlink shared channel (PDSCH) in addition to some relaxed feedback (e.g., delayed HARQ feedback). This may include a scaling in the time domain where effectively the UE is configured with a duty cycle during which the UE does not expect any PDSCH for X slots following a wideband PDSCH transmission. This may allow for the decoupling of the radio frequency (RF) and baseband component power states to enable reduction in energy consumption by the UE. For example, this may allow the UE to move the RF component(s) to a high-power state while keeping the baseband component(s) in a low-power state. When the downlink data is less than the peak throughput, gaps are guaranteed between PDSCHs and the feedback timeline is relaxed.

For example, the UE may move its internal baseband clock and voltage to a high power state when it moves to wideband scheduling. The high power state may include a higher clock frequency and generally a higher supply voltage being used to support the higher clock frequency. This may lead to a quadratic increase in power consumption by the UE as well as leakage, in some cases. For the energy efficient scheduling, the network may inform the UE of how long it will be scheduled with wideband communications such that the UE can set its clock frequency and voltage as needed and not necessarily at the highest setting corresponding to the wideband scheduling. Thus, in some networks this may include the network informing the UE that the maximum scheduled throughput will not exceed a limit, that the feedback timeline is relaxed, and that there will be gaps between PDSCHs.

In some aspects, this may enable the UE to receive a DCI grant scheduling a PDSCH transmission to the UE during a slot (e.g., the same slot as the DCI grant is received in). However, the next two slots may be unscheduled slots which allows the UE to transition its RF component(s) to a low power state while the baseband circuitry remains at a high power state in order to process the PDSCH during the next one or more slots.

In some aspects, this may be based on a buffer size or other processing capability or delay of the UE. To avoid increasing the receive fast Fourier transform (FFT) buffer size of the UE, gaps may be used between PDSCHs such that all the data has been read from the buffer before the next symbol needs to be written to the buffer. Depending on the buffer size, the UE may need to be scheduled with a number of PDSCHs (i.e., PDSCH occasions) before which a gap is required. For example, one UE may have a buffer size that can store one PDSCH's worth of data which means that the buffer must be read (e.g., the data decoded and read from the buffer) before the UE can be scheduled with the next PDSCH. Another UE may have a buffer size that can store two PDSCH's worth of data which means that the UE can be scheduled with PDSCHs is consecutive slots. However, in this example the UE cannot be scheduled with another PDSCH until the buffer storing the two PDSCHs is read. In some aspects, this may be based on the processing capability of the UE such as determining how quickly the UE can decode the data and read from the buffer.

Additionally, or alternatively, some networks may support cross-slot scheduling adaptations that uses a “minimum scheduling offset” (e.g., minimum K0 and K2 values) parameters. This may be RRC configured on a per-BWP basis. In some aspects, one bit of a DCI may be used to indicate changing between up to two configured values. This may support adaptation within a single active BWP. For example, faster switching latency may include an application delay on the order of the current minimum K0 value (e.g., down to one or two slots). This may support improved minimum scheduling offset and BWP switching for the UE and the network. For example, the minimum scheduling offset of the currently active BWP may be jointly considered with a BWP switching delay and K0/K2 restrictions for cross-BWP scheduling. In some aspects, the time domain resource allocation (TDRA) parameter of all non-active BWPs may be considered in the BWP switch scenario.

For example, grant-based resource allocation in the time domain and HARQ ACK/NACK feedback response timing may be based on various timing parameters signaled between the UE and the network. The K0 value indicates the number of slot(s) between the PDCCH carrying the DCI grant and the PDSCH transmission scheduled by the DCI grant. The K1 value indicates the number of slot(s) between the PDSCH and the HARQ ACK/NACK feedback transmission corresponding to the PDSCH. The K2 value indicates the number of slot(s) between the PDCCH and the DCI and a physical uplink shared channel (PUSCH) scheduled by the DCI. The N1 value indicates the minimum time duration required from decoding the PDCCH to be ready for reception of the PDSCH (e.g., a processing delay that may be based on UE capability). The NU value indicates the minimum time duration required from decoding PDCCH to be ready for a PUSCH transmission (e.g., based on UE capability). In some cases, these values may be set to zero or to a whole number of one or more.

Wireless networks may also support other power saving modes for the UE, such as PDCCH skipping and search space set group (SSSG) switching. For example, the UE may be configured to operate according to the power saving mode that corresponds to PDCCH skipping or SSSG switching. PDCCH skipping generally includes the UE being configured with fewer PDCCH monitoring occasions (e.g., every n^{th} slot), which reduces power consumption by the UE. The SSSG switching may allow the UE to dynamically switch between a set of SSSGs that are already configured on the active BWP of the serving cell. Each SSSG may have its own PDCCH monitoring periodicity such that switching to a different SSSG may result in fewer (e.g., sparser) PDCCH monitoring occasions during which the UE is expected to monitor for a DCI.

However, configuration or activation of the power saving mode of operations for the UE may not provide a mechanism for the UE to also be configured with energy efficient scheduling. That is, some PDCCH skipping or SSSG switching configurations provided to the UE indicate various parameters for the power saving mode (e.g., the skipping duration or sparser PDCCH monitoring occasions). However, such configuration signaling may not provide a mechanisms to configure the UE with other timing parameters related to the energy efficient scheduling (e.g., such as the K0 values, K1 values, and other values) that avoids buffer overwrites or other conflicts at the UE.

In some cases, this may include the UE being scheduled for the power saving mode (e.g., PDCCH skipping or SSSG switching) and yet without the UE also being configured for energy efficient scheduling. This may result in the UE being scheduled with back-to-back PDSCHs which prevents the UE from entering into the low power mode for the RF or baseband circuitry. This may also result in the UE overwriting the receive buffer when scheduled with back-to-back PDSCHs (e.g., two PDSCH transmissions received in contiguous slots). For example, the demapper or decoder workload may increase and in order to avoid the UE overwriting the UE buffer size the UE must quickly finish processing the first PDSCH to avoid overwriting the second PDSCH. Thus, the baseband cannot be put into a low power state (e.g., lower clock frequency or lower voltage), which may increase power consumption at the UE.

Accordingly, aspects of the techniques described herein provide for energy efficient scheduling with a limited throughput and a relaxed feedback timeline when the UE is configured with a power saving mode (e.g., PDCCH skipping or SSSG switching). For example, at 215 the network entity 210 may transmit or otherwise output (and the UE 205 may receive or otherwise obtain) a message that configures, activates, or is otherwise associated with a power saving mode for the UE 205. The power saving mode may include a set of monitoring occasions (e.g., PDCCH monitoring occasions) for the UE 205 to monitor for grant(s) that schedule wireless communications (e.g., uplink or downlink wireless communications). The message configuring, activating, or otherwise associated with the power saving mode for the UE 205 may also carry or otherwise convey information identifying a timing constraint where the wireless communications are to be scheduled in anon-contiguous slots (e.g., energy efficient scheduling). That is, the message that activates (e.g., configures or otherwise initiates) the power saving mode for the UE 205 may also identify the energy efficient scheduling timing constraint to be applied to the wireless communications.

The UE 205 may monitor the set of monitoring occasions for the grant(s) according to the power saving mode and perform the wireless communications according to a result of the monitoring. For example, at 220 the network entity 210 may transmit or otherwise output (and the UE 205 may monitor for to receive or otherwise obtain) one or more DCI grants that schedule the uplink communications or the downlink communications between the UE 205 and the network entity 210.

In some aspects, this may include the timing constraint identified in the message including a K0 indication or a K2 indication, or both indications. For example, the network entity 210 may configure or otherwise indicate to the UE 205 the configuration or activation of the power saving mode that corresponds to sparse PDCCH (e.g., PDCCH skipping) or to SSSG switching (which also result in sparse PDCCH monitoring). The network entity 210 may also indicate a maximum K0 value (e.g., the K0 value may correspond to the maximum scheduling offset guaranteed to the UE 205) as well as a relaxation of the N1/K1 indication(s). In some examples, the K0 indication, the K2 indication, or both indications may be set to a zero value.

In some aspects, the K0 indication, the K2 indication, or both indications may be set to a value that is based on a periodicity of monitoring occasions in the set of monitoring occasions. That is, the K0 indication, the K2 indication, or both indications, may be set to values that are selected to ensure the wireless communications are in non-contiguous slots. As discussed, the power saving mode (e.g., PDCCH skipping or SSSG switching) may result in the UE 205 being configured to monitor PDCCH every n^{th} slot. In some cases, this may result in two or more slots between PDCCH monitoring occasions. In this situation, the K0 indication, the K2 indication, or both indications, may be set to values that ensure there is at least one non-PDSCH slot between subsequent PDSCH slots. As one non-limiting example, a DCI grant received in slot 0 may schedule a PDSCH in slot 1 when the next PDCCH monitoring occasion is in slot 3 (e.g., slot 2 is blank, therefore avoiding contiguous PDSCHs).

In some aspects, the message activating the power saving mode for the UE 205 may include a BWP configuration message. For example, the configuration may be part of a power saving BWP configuration (such as a BWP configuration with sparse SSSG). In some aspects, the message activating the power saving mode for the UE 205 may include a grant that schedules a first wireless communications. For example, the indication may be included in the same scheduling DCI that schedules the PDSCH and indicates the PDCCH skipping/sparse PDCCH and guarantees the timing constraint (e.g., that K0 is set to zero, in some examples). Accordingly, the techniques described herein provide for an enhanced PDCCH monitoring adaptation that not only adapts the PDCCH but also allows the UE 205 to relax the baseband processing of the PDSCH (thus achieving improved energy efficiency).

In some aspects, the timing constraint may be based on the capabilities of the UE 205. For example, the UE 205 may transmit or otherwise output (and the network entity 210 may receive or otherwise obtain) a UE capability message that identifies the supported timing constraint(s) of the UE 205. The timing constraint identified in the message activating the power saving mode for the UE 205 may be based on the supported timing constraint(s) of the UE 205. In some cases, the UE capability message may be transmitted in a UE assistance information (UAI) message, in a medium access control-control element (MAC-CE), or in an uplink control information (UCI) message.

In some aspects, the timing constraint may be configured on a per-BWP basis associated with the power saving mode or is adapted within a BWP configured for the UE 205. For example, the K0 indication (e.g., K0max), the K2 indication (e.g., K2max), or both indications may be configured per-BWP (e.g., part of the limited throughput energy efficient BWP). As another example, the K0 indication (e.g., K0max), the K2 indication (e.g., K2max), or both indications may be adapted within the BWP (e.g., via DCI, MAC-CE, or RRC reconfiguration signaling).

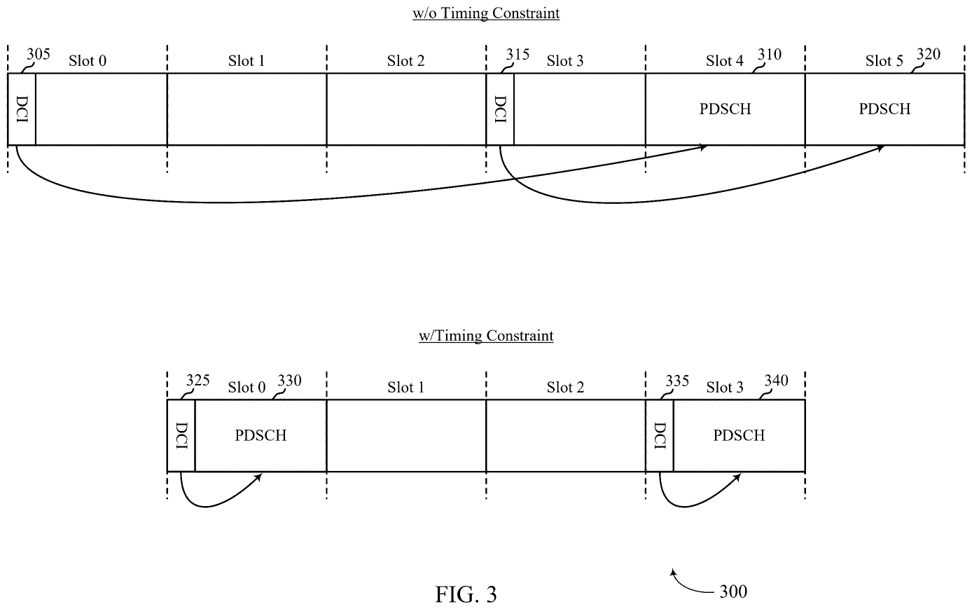

FIG. 3 shows an example of a scheduling configuration 300 that supports scheduling aspects for UE power saving mode in accordance with one or more aspects of the present disclosure. Aspects of the scheduling configuration 300 may be implemented at or implemented by aspects of the wireless communications system 100 or the wireless communications system 200. Aspects of the scheduling configuration 300 may be implemented at or implemented by a UE or a network entity, which may be examples of the corresponding devices described herein.

As discussed above, the techniques described herein provide for a UE to be activated or otherwise configured to operate in a power saving mode to conserve energy. For example, the UE may receive or otherwise obtain a message that configures, activates, or is otherwise associated with the power saving mode for the UE. Examples of the power saving mode include, but are not limited to, PDCCH skipping or SSSG switching. Accordingly, the power saving mode may include a set of monitoring occasions (e.g., PDCCH monitoring occasions) for the UE to monitor for grant(s) that schedule wireless communications. The message that activates, configures, or otherwise initiates the power saving mode for the UE may also carry or otherwise convey information that identifies a timing constraint (e.g., a K0 indication, a K2 indication, or other timing parameter indication) where the wireless communications are to be scheduled in non-contiguous slots.

That is, the timing constraint may be set to a value that guarantees that the UE will not be scheduled for PDSCH in contiguous slots to improve energy efficiency at the RF or baseband component(s) of the UE. In the situation where the UE capability signaling indicates the UE can support two back-to-back PDSCHs (e.g., based on the buffer size of the UE), the timing constraint may indicate or otherwise guarantee that the UE cannot be scheduled with more than two PDSCHs without a gap to allow baseband processing of those PDSCHs.

Accordingly, the UE may monitor the set of monitoring occasions for the grant(s) according to the power saving mode. For example, the UE may perform PDCCH monitoring for DCI grants during set of monitoring occasions where each monitoring occasion occurs every n^{th} slot. The UE and the network entity may perform the wireless communications according to the result of the monitoring. For example, the UE and the network entity may perform wireless communications (e.g., uplink or downlink communications) when a DCI grant is detected during a PDCCH monitoring occasion. The UE and the network entity may not perform wireless communications when the UE does not detect a DCI grant during a monitoring occasion.

Scheduling configuration 300 illustrates two examples of when the UE operating in the power saving mode when not configured with the timing constraint and when the UE operates in the power saving mode when configured with the timing constraint. For the first example, this may include the UE being configured with the power saving mode such that the set of monitoring occasions occur every third slot (e.g., n=3). For example, the set of monitoring occasions in this example includes a slot 0 and a slot 3 where the UE monitors for DCI grants. However, in this example the message that activates the power saving mode for the UE does not identify the timing constraint (e.g., does not indicate energy efficient scheduling). This may result in the situation that the DCI grant 305 received during slot 0 schedules a PDSCH 310 during slot 4 and the DCI grant 315 received during slot 3 schedules a PDSCH 320 during slot 5. Thus, in this situation where the message activating the power saving mode for the UE does not identify the timing constraint this may result in the PDSCH 310 and the PDSCH 320 being scheduled in contiguous slots (e.g., during slot 4 and slot 5). This may result in buffer overwrite or the UE being unable to reduce the operating clock frequency or voltage of the baseband circuitry.

However, the second example shown in scheduling configuration 300 illustrates an example where the message activating the power saving mode for the UE also identifies the timing constraint according to the techniques described herein. In this example, this may include the UE receiving a DCI grant 325 during a slot 0 that schedules a PDSCH 330 also during the slot 0. This may also include the UE receiving a DCI grant 335 during the slot 3 that schedules a PDSCH 340 also during the slot 3. Thus, in this example the wireless communications occur in non-contiguous slots according to the timing constraint. More particularly, in this example the timing constraint includes a K0 indication, a K2 indication, or both indications where the values are set to zero. This may allow the UE to enter the low power state for its RF components during slot 1 and slot 2 (e.g., depending on its processing capabilities and delays).

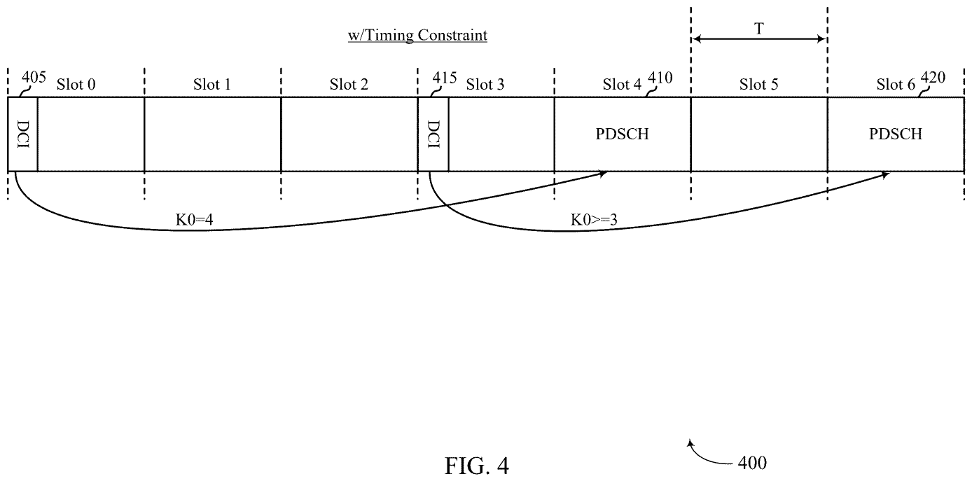

FIG. 4 shows an example of a scheduling configuration 400 that supports scheduling aspects for UE power saving mode in accordance with one or more aspects of the present disclosure. Aspects of the scheduling configuration 400 may be implemented at or implemented by aspects of the wireless communications system 100 or the wireless communications system 200 or aspects of the scheduling configuration 300. Aspects of the scheduling configuration 400 may be implemented at or implemented by a UE or a network entity, which may be examples of the corresponding devices described herein.

As discussed above, the techniques described herein provide for a UE to be activated or otherwise configured to operate in a power saving mode to conserve energy. For example, the UE may receive or otherwise obtain a message that configures, activates, or is otherwise associated with the power saving mode for the UE. Examples of the power saving mode include, but are not limited to, PDCCH skipping or SSSG switching. Accordingly, the power saving mode may include a set of monitoring occasions (e.g., PDCCH monitoring occasions) for the UE to monitor for grant(s) that schedule wireless communications. The message that activates, configures, or otherwise initiates the power saving mode for the UE may also carry or otherwise convey information that identifies a timing constraint (e.g., a K0 indication, a K2 indication, or other timing parameter indication) where the wireless communications are to be scheduled in non-contiguous slots.

Accordingly, the UE may monitor the set of monitoring occasions for the grant(s) according to the power saving mode. For example, the UE may perform PDCCH monitoring for DCI grants during set of monitoring occasions where each monitoring occasion occurs every n^{th} slot. The UE and the network entity may perform the wireless communications according to the result of the monitoring. For example, the UE and the network entity may perform wireless communications (e.g., uplink or downlink communications) when a DCI grant is detected during a PDCCH monitoring occasion. The UE and the network entity may not perform wireless communications when the UE does not detect a DCI grant during a monitoring occasion.

Scheduling configuration 400 illustrates an example where, when the UE is indicated to switch to a sparse SSSG this may include indicating that the UE is not to be expected to be scheduled with a second PDSCH from a first scheduled PDSCH at a timeline T. T, in this context, may depend on the buffer size of the UE and the UE capability to process the PDSCH at the lower clock speed and lower voltage. For example, the timing constraint in this example that is identified in the message may include a timing offset value (e.g., T) between subsequently scheduled wireless communications in the non-contiguous slots. Value(s) for a second K0 indication or a second K2 indication associated with second wireless communications are excluded according to value(s) of a first K0 indication or a first K2 indication associated with a first wireless communications scheduled prior to the second wireless communications.

Thus, in this example the timing constraint identified in the message (e.g., T in this example) that activates the power saving mode for the UE may include the UE receiving a DCI grant 405 during a slot 0 that schedules a PDSCH 410 during a slot 4 and receiving a DCI grant 415 that schedules a PDSCH 420 during a slot 6. Thus, the K0 value indicated in the DCI grant 405 may be set to four and the K0 value indicated in the DCI grant 415 may be set to three. Accordingly, the timing constraint in this example prevents the K0 value in the DCI grant 415 from scheduling a PDSCH in a slot that is contiguous with the slot 4 that the DCI grant 405 scheduled the PDSCH 410 during. In some aspects, the timing offset value may be based on a buffer size of the UE, a processing delay of the UE, or both. For example, the network entity may consider the UE buffer size or processing delay (e.g., as reported in UE capability signaling) when selecting the valid K0 values to indicate in the DCI grants.

Thus, in this example the valid values of K0 for the second scheduled PDSCH after the first scheduled PDSCH are limited or otherwise restricted to guarantee gap(s) between the back-to-back PDSCHs even though these values may be RRC configured for a larger set of values. For example, a first PDSCH can be scheduled with K0=4 but the UE does not expect a second PDSCH with K0<=3. In some aspects, the UE may not expect certain PDSCHs due to out-of-order scheduling. However, according to the techniques described herein there are valid K0 values that are excluded due to the energy efficient scheduling.

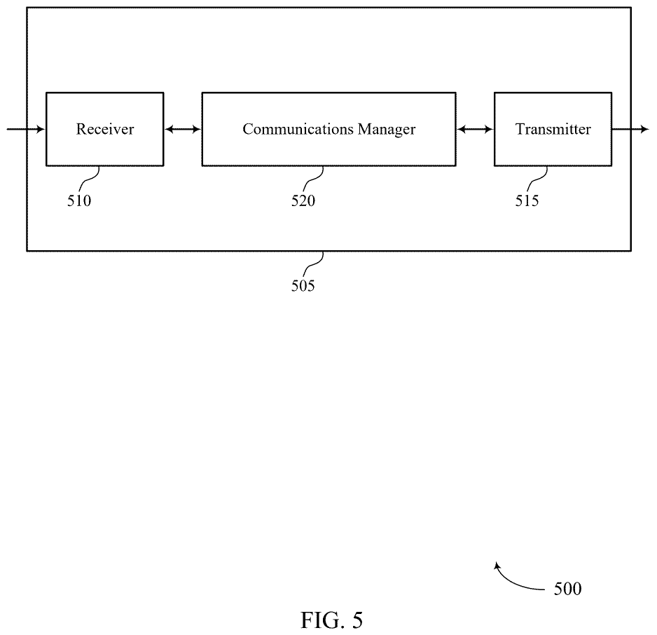

FIG. 5 shows a block diagram 500 of a device 505 that supports scheduling aspects for UE power saving mode in accordance with one or more aspects of the present disclosure. The device 505 may be an example of aspects of a UE 115 as described herein. The device 505 may include a receiver 510, a transmitter 515, and a communications manager 520. The device 505, or one or more components of the device 505 (e.g., the receiver 510, the transmitter 515, the communications manager 520), may include at least one processor, which may be coupled with at least one memory, to, individually or collectively, support or enable the described techniques. Each of these components may be in communication with one another (e.g., via one or more buses).

The receiver 510 may provide a means for receiving information such as packets, user data, control information, or any combination thereof associated with various information channels (e.g., control channels, data channels, information channels related to scheduling aspects for UE power saving mode). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to scheduling aspects for UE power saving mode). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations or components thereof may be examples of means for performing various aspects of scheduling aspects for UE power saving mode as described herein. For example, the communications manager 520, the receiver 510, the transmitter 515, or various combinations or components thereof may be capable of performing one or more of the functions described herein.

In some examples, the communications manager 520, the receiver 510, the transmitter 515, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 520, the receiver 510, the transmitter 515, or various combinations or components thereof may be implemented in code (e.g., as communications management software or firmware) executed by at least one processor (e.g., referred to as a processor-executable code). If implemented in code executed by at least one processor, the functions of the communications manager 520, the receiver 510, the transmitter 515, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications in accordance with examples as disclosed herein. For example, the communications manager 520 is capable of, configured to, or operable to support a means for receiving a message that activates a power saving mode for the UE, the power saving mode including a set of monitoring occasions for the UE to monitor for one or more grants that schedule wireless communications, where the message identifies a timing constraint where the wireless communications are to be scheduled in non-contiguous slots. The communications manager 520 is capable of, configured to, or operable to support a means for monitoring the set of monitoring occasions for the one or more grants according to the power saving mode. The communications manager 520 is capable of, configured to, or operable to support a means for performing the wireless communications according to a result of the monitoring.

By including or configuring the communications manager 520 in accordance with examples as described herein, the device 505 (e.g., at least one processor controlling or otherwise coupled with the receiver 510, the transmitter 515, the communications manager 520, or a combination thereof) may support techniques for improved power saving modes for a UE that enable energy efficient scheduling according to a timing constraint indicated in the message that configures, activates, or otherwise initiates or is associated with the power saving mode for the UE.

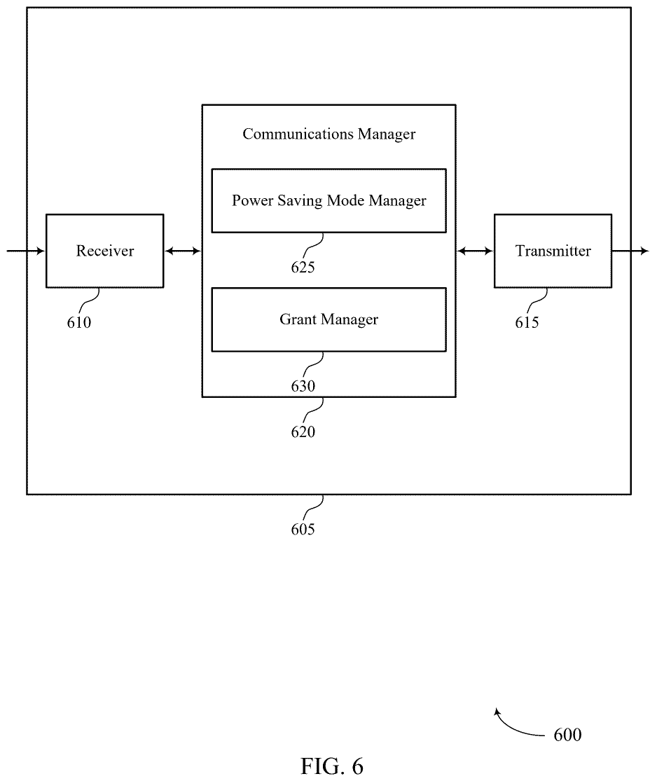

FIG. 6 shows a block diagram 600 of a device 605 that supports scheduling aspects for UE power saving mode in accordance with one or more aspects of the present disclosure. The device 605 may be an example of aspects of a device 505 or a UE 115 as described herein. The device 605 may include a receiver 610, a transmitter 615, and a communications manager 620. The device 605, or one of more components of the device 605 (e.g., the receiver 610, the transmitter 615, the communications manager 620), may include at least one processor, which may be coupled with at least one memory, to support the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to scheduling aspects for UE power saving mode). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to scheduling aspects for UE power saving mode). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of scheduling aspects for UE power saving mode as described herein. For example, the communications manager 620 may include a power saving mode manager 625 a grant manager 630, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications in accordance with examples as disclosed herein. The power saving mode manager 625 is capable of, configured to, or operable to support a means for receiving a message that activates a power saving mode for the UE, the power saving mode including a set of monitoring occasions for the UE to monitor for one or more grants that schedule wireless communications, where the message identifies a timing constraint where the wireless communications are to be scheduled in non-contiguous slots. The grant manager 630 is capable of, configured to, or operable to support a means for monitoring the set of monitoring occasions for the one or more grants according to the power saving mode. The grant manager 630 is capable of, configured to, or operable to support a means for performing the wireless communications according to a result of the monitoring.

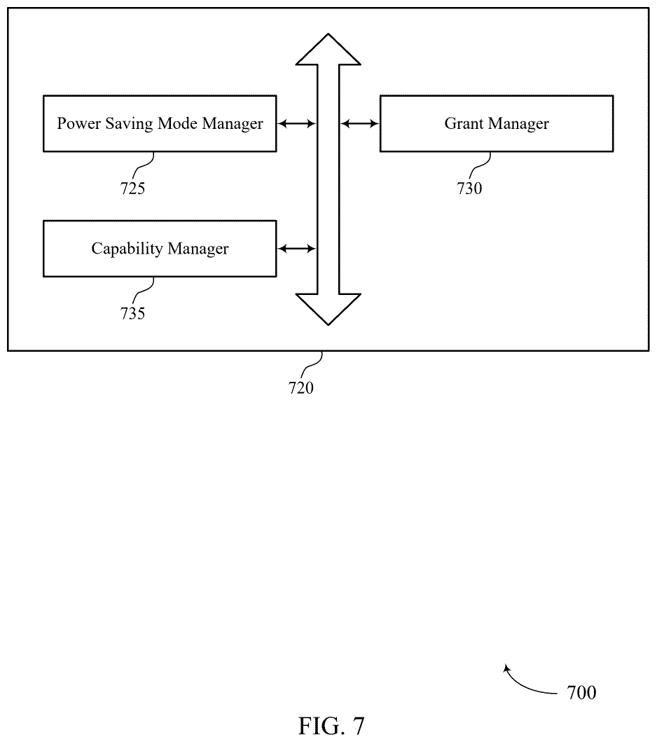

FIG. 7 shows a block diagram 700 of a communications manager 720 that supports scheduling aspects for UE power saving mode in accordance with one or more aspects of the present disclosure. The communications manager 720 may be an example of aspects of a communications manager 520, a communications manager 620, or both, as described herein. The communications manager 720, or various components thereof, may be an example of means for performing various aspects of scheduling aspects for UE power saving mode as described herein. For example, the communications manager 720 may include a power saving mode manager 725, a grant manager 730, a capability manager 735, or any combination thereof. Each of these components, or components or subcomponents thereof (e.g., one or more processors, one or more memories), may communicate, directly or indirectly, with one another (e.g., via one or more buses).

The communications manager 720 may support wireless communications in accordance with examples as disclosed herein. The power saving mode manager 725 is capable of, configured to, or operable to support a means for receiving a message that activates a power saving mode for the UE, the power saving mode including a set of monitoring occasions for the UE to monitor for one or more grants that schedule wireless communications, where the message identifies a timing constraint where the wireless communications are to be scheduled in non-contiguous slots. The grant manager 730 is capable of, configured to, or operable to support a means for monitoring the set of monitoring occasions for the one or more grants according to the power saving mode. In some examples, the grant manager 730 is capable of, configured to, or operable to support a means for performing the wireless communications according to a result of the monitoring.

In some examples, the timing constraint identified in the message includes a K0 indication or a K2 indication. In some examples, the K0 indication or the K2 indication is set to zero. In some examples, the K0 indication or the K2 indication is set to a value that is based on a periodicity of monitoring occasions in the set of monitoring occasions, the value being selected to schedule the wireless communications in the non-contiguous slots. In some examples, the timing constraint identified in the message includes a timing offset value between subsequently scheduled wireless communications in the non-contiguous slots.

In some examples, one or more values for second K0 indications or second K2 indications associated with second wireless communications are excluded according to one or more values for a first K0 indication or a first K2 indication associated with a first wireless communication scheduled prior to the second wireless communications. In some examples, the timing offset value is based on at least one of a buffer size of the UE, a processing delay of the UE, or any combination thereof. In some examples, the message includes a bandwidth part configuration message that activates the power saving mode for the UE. In some examples, the message includes a grant that schedules a first wireless communications and activates the power saving mode for the UE.

In some examples, the capability manager 735 is capable of, configured to, or operable to support a means for transmitting a UE capability message that identifies a supported timing constraint of the UE, where the timing constraint is based on the supported timing constraint of the UE. In some examples, the timing constraint is configured on a per-BWP-basis associated with the power saving mode or is adapted within a BWP configured for the UE.

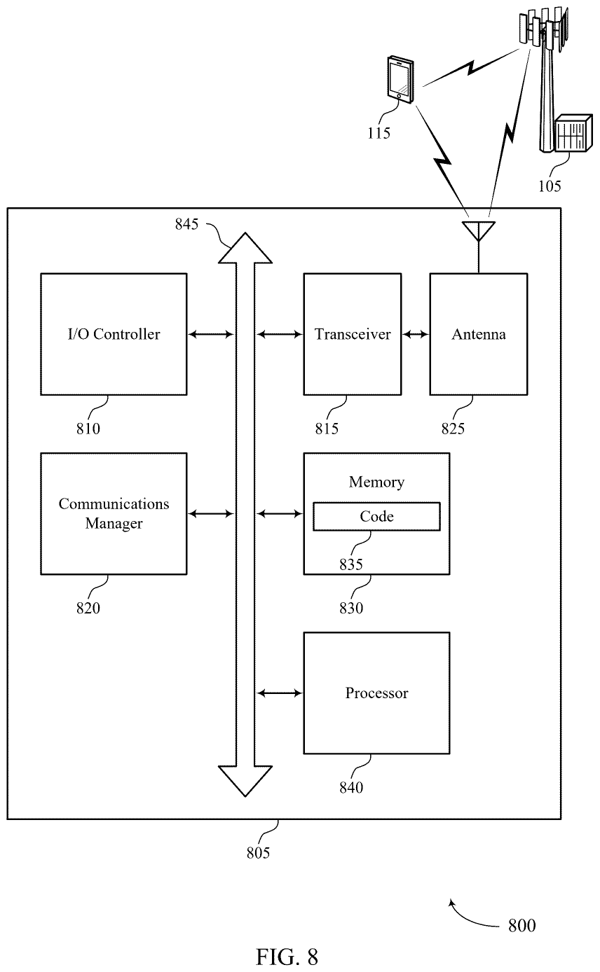

FIG. 8 shows a diagram of a system 800 including a device 805 that supports scheduling aspects for UE power saving mode in accordance with one or more aspects of the present disclosure. The device 805 may be an example of or include components of a device 505, a device 605, or a UE 115 as described herein. The device 805 may communicate (e.g., wirelessly) with one or more other devices (e.g., network entities 105, UEs 115, or a combination thereof). The device 805 may include components for bi-directional voice and data communications including components for transmitting and receiving communications, such as a communications manager 820, an input/output (I/O) controller, such as an I/O controller 810, a transceiver 815, one or more antennas 825, at least one memory 830, code 835, and at least one processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally, or alternatively, the I/O controller 810 may represent or interact with a modem, a keyboard, a mouse, a touchscreen, or a similar device. In some cases, the I/O controller 810 may be implemented as part of one or more processors, such as the at least one processor 840. In some cases, a user may interact with the device 805 via the I/O controller 810 or via hardware components controlled by the I/O controller 810.

In some cases, the device 805 may include a single antenna. However, in some other cases, the device 805 may have more than one antenna, which may be capable of concurrently transmitting or receiving multiple wireless transmissions. The transceiver 815 may communicate bi-directionally via the one or more antennas 825 using wired or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The at least one memory 830 may include random access memory (RAM) and read-only memory (ROM). The at least one memory 830 may store computer-readable, computer-executable, or processor-executable code, such as the code 835. The code 835 may include instructions that, when executed by the at least one processor 840, cause the device 805 to perform various functions described herein. The code 835 may be stored in a non-transitory computer-readable medium such as system memory or another type of memory. In some cases, the code 835 may not be directly executable by the at least one processor 840 but may cause a computer (e.g., when compiled and executed) to perform functions described herein. In some cases, the at least one memory 830 may include, among other things, a basic I/O system (BIOS) which may control basic hardware or software operation such as the interaction with peripheral components or devices.

The at least one processor 840 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 840 may be configured to operate a memory array using a memory controller. In some other cases, a memory controller may be integrated into the at least one processor 840. The at least one processor 840 may be configured to execute computer-readable instructions stored in a memory (e.g., the at least one memory 830) to cause the device 805 to perform various functions (e.g., functions or tasks supporting scheduling aspects for UE power saving mode). For example, the device 805 or a component of the device 805 may include at least one processor 840 and at least one memory 830 coupled with or to the at least one processor 840, the at least one processor 840 and the at least one memory 830 configured to perform various functions described herein.

In some examples, the at least one processor 840 may include multiple processors and the at least one memory 830 may include multiple memories. One or more of the multiple processors may be coupled with one or more of the multiple memories, which may, individually or collectively, be configured to perform various functions described herein. In some examples, the at least one processor 840 may be a component of a processing system, which may refer to a system (such as a series) of machines, circuitry (including, for example, one or both of processor circuitry (which may include the at least one processor 840) and memory circuitry (which may include the at least one memory 830)), or components, that receives or obtains inputs and processes the inputs to produce, generate, or obtain a set of outputs. The processing system may be configured to perform one or more of the functions described herein. For example, the at least one processor 840 or a processing system including the at least one processor 840 may be configured to, configurable to, or operable to cause the device 805 to perform one or more of the functions described herein. Further, as described herein, being “configured to,” being “configurable to,” and being “operable to” may be used interchangeably and may be associated with a capability, when executing code 835 (e.g., processor-executable code) stored in the at least one memory 830 or otherwise, to perform one or more of the functions described herein.

The communications manager 820 may support wireless communications in accordance with examples as disclosed herein. For example, the communications manager 820 is capable of, configured to, or operable to support a means for receiving a message that activates a power saving mode for the UE, the power saving mode including a set of monitoring occasions for the UE to monitor for one or more grants that schedule wireless communications, where the message identifies a timing constraint where the wireless communications are to be scheduled in non-contiguous slots. The communications manager 820 is capable of, configured to, or operable to support a means for monitoring the set of monitoring occasions for the one or more grants according to the power saving mode. The communications manager 820 is capable of, configured to, or operable to support a means for performing the wireless communications according to a result of the monitoring.

By including or configuring the communications manager 820 in accordance with examples as described herein, the device 805 may support techniques for improved power saving modes for a UE that enable energy efficient scheduling according to a timing constraint indicated in the message that configures, activates, or otherwise initiates or is associated with the power saving mode for the UE.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the at least one processor 840, the at least one memory 830, the code 835, or any combination thereof. For example, the code 835 may include instructions executable by the at least one processor 840 to cause the device 805 to perform various aspects of scheduling aspects for UE power saving mode as described herein, or the at least one processor 840 and the at least one memory 830 may be otherwise configured to, individually or collectively, perform or support such operations.

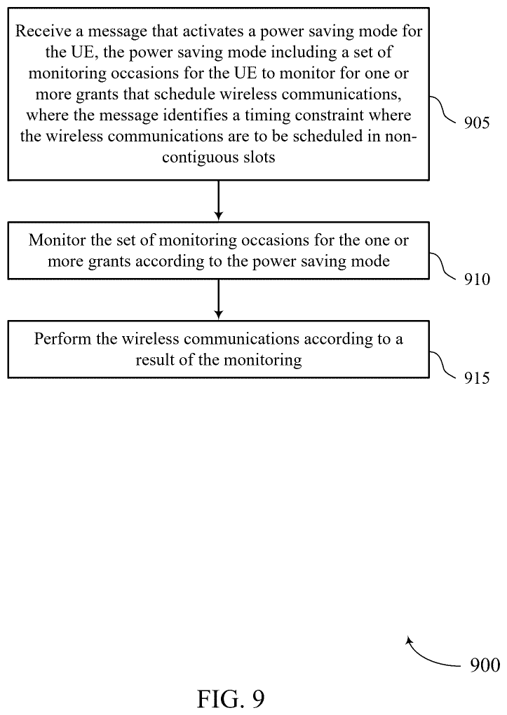

FIG. 9 shows a flowchart illustrating a method 900 that supports scheduling aspects for UE power saving mode in accordance with one or more aspects of the present disclosure. The operations of the method 900 may be implemented by a UE or its components as described herein. For example, the operations of the method 900 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 905, the method may include receiving a message that activates a power saving mode for the UE, the power saving mode including a set of monitoring occasions for the UE to monitor for one or more grants that schedule wireless communications, where the message identifies a timing constraint where the wireless communications are to be scheduled in non-contiguous slots. The operations of 905 may be performed in accordance with examples as disclosed herein. In some examples, aspects of the operations of 905 may be performed by a power saving mode manager 725 as described with reference to FIG. 7.

At 910, the method may include monitoring the set of monitoring occasions for the one or more grants according to the power saving mode. The operations of 910 may be performed in accordance with examples as disclosed herein. In some examples, aspects of the operations of 910 may be performed by a grant manager 730 as described with reference to FIG. 7.

At 915, the method may include performing the wireless communications according to a result of the monitoring. The operations of 915 may be performed in accordance with examples as disclosed herein. In some examples, aspects of the operations of 915 may be performed by a grant manager 730 as described with reference to FIG. 7.

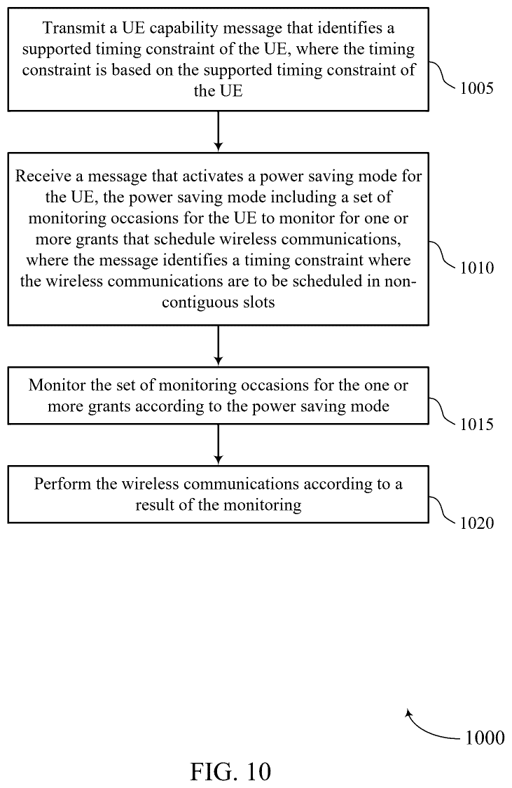

FIG. 10 shows a flowchart illustrating a method 1000 that supports scheduling aspects for UE power saving mode in accordance with one or more aspects of the present disclosure. The operations of the method 1000 may be implemented by a UE or its components as described herein. For example, the operations of the method 1000 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1005, the method may include transmitting a UE capability message that identifies a supported timing constraint of the UE, where the timing constraint is based on the supported timing constraint of the UE. The operations of 1005 may be performed in accordance with examples as disclosed herein. In some examples, aspects of the operations of 1005 may be performed by a capability manager 735 as described with reference to FIG. 7.

At 1010, the method may include receiving a message that activates a power saving mode for the UE, the power saving mode including a set of monitoring occasions for the UE to monitor for one or more grants that schedule wireless communications, where the message identifies a timing constraint where the wireless communications are to be scheduled in non-contiguous slots. The operations of 1010 may be performed in accordance with examples as disclosed herein. In some examples, aspects of the operations of 1010 may be performed by a power saving mode manager 725 as described with reference to FIG. 7.

At 1015, the method may include monitoring the set of monitoring occasions for the one or more grants according to the power saving mode. The operations of 1015 may be performed in accordance with examples as disclosed herein. In some examples, aspects of the operations of 1015 may be performed by a grant manager 730 as described with reference to FIG. 7.

At 1020, the method may include performing the wireless communications according to a result of the monitoring. The operations of 1020 may be performed in accordance with examples as disclosed herein. In some examples, aspects of the operations of 1020 may be performed by a grant manager 730 as described with reference to FIG. 7.

The following provides an overview of aspects of the present disclosure:

Aspect 1: A method for wireless communications at a UE, comprising: receiving a message that activates a power saving mode for the UE, the power saving mode comprising a set of monitoring occasions for the UE to monitor for one or more grants that schedule wireless communications, wherein the message identifies a timing constraint where the wireless communications are to be scheduled in non-contiguous slots; monitoring the set of monitoring occasions for the one or more grants according to the power saving mode; and performing the wireless communications according to a result of the monitoring.

Aspect 2: The method of aspect 1, wherein the timing constraint identified in the message comprises a K0 indication or a K2 indication.

Aspect 3: The method of aspect 2, wherein the K0 indication or the K2 indication is set to zero.

Aspect 4: The method of any of aspects 2 through 3, wherein the K0 indication or the K2 indication is set to a value that is based on a periodicity of monitoring occasions in the set of monitoring occasions, the value being selected to schedule the wireless communications in the non-contiguous slots.

Aspect 5: The method of any of aspects 1 through 4, wherein the timing constraint identified in the message comprises a timing offset value between subsequently scheduled wireless communications in the non-contiguous slots.

Aspect 6: The method of aspect 5, wherein one or more values for second K0 indications or second K2 indications associated with second wireless communications are excluded according to one or more values for a first K0 indication or a first K2 indication associated with a first wireless communication scheduled prior to the second wireless communications.

Aspect 7: The method of any of aspects 5 through 6, wherein the timing offset value is based on at least one of a buffer size of the UE, a processing delay of the UE, or any combination thereof.

Aspect 8: The method of any of aspects 1 through 7, wherein the message comprises a bandwidth part configuration message that activates the power saving mode for the UE.

Aspect 9: The method of any of aspects 1 through 8, wherein the message comprises a grant that schedules a first wireless communications and activates the power saving mode for the UE.

Aspect 10: The method of any of aspects 1 through 9, further comprising: transmitting a UE capability message that identifies a supported timing constraint of the UE, wherein the timing constraint is based on the supported timing constraint of the UE.

Aspect 11: The method of any of aspects 1 through 10, wherein the timing constraint is configured on a per-BWP-basis associated with the power saving mode or is adapted within a BWP configured for the UE.

Aspect 12: A UE for wireless communications, comprising one or more memories storing processor-executable code, and one or more processors coupled with the one or more memories and individually or collectively operable to execute the code to cause the UE to perform a method of any of aspects 1 through 11.

Aspect 13: A UE for wireless communications, comprising at least one means for performing a method of any of aspects 1 through 11.

Aspect 14: A non-transitory computer-readable medium storing code for wireless communications, the code comprising instructions executable by one or more processors to perform a method of any of aspects 1 through 11.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive a message that activates a power saving mode for the UE, the power saving mode comprising a set of monitoring occasions for the UE to monitor for one or more grants that schedule wireless communications, wherein the message identifies a timing constraint where the wireless communications are to be scheduled in non-contiguous slots;
monitor the set of monitoring occasions for the one or more grants according to the power saving mode; and
perform the wireless communications according to a result of the monitoring.

2. The UE of claim 1, wherein the timing constraint identified in the message comprises a K0 indication or a K2 indication.

3. The UE of claim 2, wherein:
the K0 indication or the K2 indication is set to zero.

4. The UE of claim 2, wherein the K0 indication or the K2 indication is set to a value that is based on a periodicity of monitoring occasions in the set of monitoring occasions, the value being selected to schedule the wireless communications in the non-contiguous slots.

5. The UE of claim 1, wherein the timing constraint identified in the message comprises a timing offset value between subsequently scheduled wireless communications in the non-contiguous slots.

6. The UE of claim 5, wherein one or more values for second K0 indications or second K2 indications associated with second wireless communications are excluded according to one or more values for a first K0 indication or a first K2 indication associated with a first wireless communication scheduled prior to the second wireless communications.

7. The UE of claim 5, wherein the timing offset value is based on at least one of a buffer size of the UE, a processing delay of the UE, or any combination thereof.

8. The UE of claim 1, wherein the message comprises a bandwidth part configuration message that activates the power saving mode for the UE.

9. The UE of claim 1, wherein the message comprises a grant that schedules a first wireless communications and activates the power saving mode for the UE.

10. The UE of claim 1, wherein the one or more processors are individually or collectively further operable to execute the code to cause the UE to:
transmit a UE capability message that identifies a supported timing constraint of the UE, wherein the timing constraint is based on the supported timing constraint of the UE.

11. The UE of claim 1, wherein the timing constraint is configured on a per-bandwidth part (BWP)-basis associated with the power saving mode or is adapted within a BWP configured for the UE.

12. A method for wireless communications at a user equipment (UE), comprising:
receiving a message that activates a power saving mode for the UE, the power saving mode comprising a set of monitoring occasions for the UE to monitor for one or more grants that schedule wireless communications, wherein the message identifies a timing constraint where the wireless communications are to be scheduled in non-contiguous slots;
monitoring the set of monitoring occasions for the one or more grants according to the power saving mode; and
performing the wireless communications according to a result of the monitoring.

13. The method of claim 12, wherein the timing constraint identified in the message comprises a K0 indication or a K2 indication.

14. The method of claim 13, wherein the K0 indication or the K2 indication is set to zero.

15. The method of claim 13, wherein the K0 indication or the K2 indication is set to a value that is based on a periodicity of monitoring occasions in the set of monitoring occasions, the value being selected to schedule the wireless communications in the non-contiguous slots.

16. The method of claim 12, wherein the timing constraint identified in the message comprises a timing offset value between subsequently scheduled wireless communications in the non-contiguous slots.

17. The method of claim 16, wherein one or more values for second K0 indications or second K2 indications associated with second wireless communications are excluded according to one or more values for a first K0 indication or a first K2 indication associated with a first wireless communication scheduled prior to the second wireless communications.

18. The method of claim 16, wherein the timing offset value is based on at least one of a buffer size of the UE, a processing delay of the UE, or any combination thereof.

19. The method of claim 12, wherein the message comprises a bandwidth part configuration message that activates the power saving mode for the UE.

20. The method of claim 12, wherein the message comprises a grant that schedules a first wireless communications and activates the power saving mode for the UE.

21. The method of claim 12, further comprising:
transmitting a UE capability message that identifies a supported timing constraint of the UE, wherein the timing constraint is based on the supported timing constraint of the UE.

22. The method of claim 12, wherein the timing constraint is configured on a per-bandwidth part (BWP)-basis associated with the power saving mode or is adapted within a BWP configured for the UE.

23. A user equipment (UE) for wireless communications, comprising:
means for receiving a message that activates a power saving mode for the UE, the power saving mode comprising a set of monitoring occasions for the UE to monitor for one or more grants that schedule wireless communications, wherein the message identifies a timing constraint where the wireless communications are to be scheduled in non-contiguous slots;
means for monitoring the set of monitoring occasions for the one or more grants according to the power saving mode; and
means for performing the wireless communications according to a result of the monitoring.

24. A non-transitory computer-readable medium storing code for wireless communications, the code comprising instructions executable by one or more processors to:
receive a message that activates a power saving mode for a user equipment (UE), the power saving mode comprising a set of monitoring occasions for the UE to monitor for one or more grants that schedule wireless communications, wherein the message identifies a timing constraint where the wireless communications are to be scheduled in non-contiguous slots;
monitor the set of monitoring occasions for the one or more grants according to the power saving mode; and
perform the wireless communications according to a result of the monitoring.

25. The non-transitory computer-readable medium of claim 24, wherein the timing constraint identified in the message comprises a K0 indication or a K2 indication.

26. The non-transitory computer-readable medium of claim 25, wherein:
the K0 indication or the K2 indication is set to zero.

27. The non-transitory computer-readable medium of claim 25, wherein the K0 indication or the K2 indication is set to a value that is based on a periodicity of monitoring occasions in the set of monitoring occasions, the value being selected to schedule the wireless communications in the non-contiguous slots.

28. The non-transitory computer-readable medium of claim 24, wherein the timing constraint identified in the message comprises a timing offset value between subsequently scheduled wireless communications in the non-contiguous slots.

29. The non-transitory computer-readable medium of claim 28, wherein one or more values for second K0 indications or second K2 indications associated with second wireless communications are excluded according to one or more values for a first K0 indication or a first K2 indication associated with a first wireless communication scheduled prior to the second wireless communications.

30. The non-transitory computer-readable medium of claim 28, wherein the timing offset value is based on at least one of a buffer size of the UE, a processing delay of the UE, or any combination thereof.
